(19) United States
(12) Patent Application Publication
(10) Pub. No.: US 2020/0339013 A1
(43) Pub. Date: Oct. 29, 2020

(54) VEHICLE AND METHOD FOR CONTROLLING THEREOF

(71) Applicants: HYUNDAI MOTOR COMPANY, Seoul (KR); KIA MOTORS CORPORATION, Seoul (KR)

(72) Inventors: Kyung-joo BANG, Seoul (KR); Hong Gi PARK, Seoul (KR); Seunghyun KIM, Seoul (KR); Ilhwan KIM, Hwaseong-si (KR); Donghyuk KIM, Hwaseong-si (KR)

(73) Assignees: HYUNDAI MOTOR COMPANY, Seoul (KR); KIA MOTORS CORPORATION, Seoul (KR)

(21) Appl. No.: 16/658,375

(22) Filed: Oct. 21, 2019

(30) Foreign Application Priority Data
Apr. 23, 2019 (KR) 10-2019-0047391

(51) Int. Cl. B60N 2/07; B60N 2/005; B60W 30/08

(52) U.S. Cl. CPC B60N 2/0735; B60N 2/005; B60W 2300/10; B60W 2030/082; B60W 30/08

(57) ABSTRACT

A vehicle includes: a vehicle status sensor to detect a vehicle status; a seat control motor to move a sliding seat of the vehicle; and a controller to control the seat control motor to move the sliding seat to a predetermined position when the vehicle status sensor detects an accident of the vehicle. With the features, the vehicle automatically returns the sliding seat to an original position when an accident occurs in the vehicle.

### CROSS-REFERENCE TO RELATED APPLICATION

This application claims priority to and the benefit of Korean Patent Application No. 10-2019-0047391, filed on Apr. 23, 2019, the entire contents of which are incorporated herein by reference.

### FIELD

The present disclosure relate to a vehicle and a method for controlling thereof, and more particularly to a technology for automatically returning a sliding seat to a position.

### BACKGROUND

The statements in this section merely provide background information related to the present disclosure and may not constitute prior art.

In general, in the case of buses that travel long distances such as city buses and express buses, seats are arranged on both sides with respect to an aisle in the center of the bus body. In most cases, double row seats are arranged on both sides of the aisle, and at the rear, five seats are provided for five passengers to sit. Not all buses have such a structure, and some have double-row seats arranged on one side of the central aisle and independent seats arranged on the other side, such as the recent premium bus.

In the case of long-distance buses such as intercity buses and high-speed buses, since the passengers do not move for a long time after boarding, the center aisle space is rarely used. Therefore, if the space between the seats is formed by utilizing this space, the space with the next person can be widened even if the seat of the same size is used.

In this way, recently, sliding bus seats have been developed that allow large physiques to travel comfortably without contact with the person next to them by moving the seat in the direction of the center aisle, which is a space not used during driving of the bus.

On the other hand, we have discovered that the distance between the seats can be secured by moving the seat in the aisle direction, but in the event of a fire or crash in a vehicle, the aisle narrowed by the moving seat may impede the rapid escape of the passenger.

### SUMMARY

The present disclosure provides a vehicle capable of securing an escape passage in case of emergency by automatically returning a sliding seat to an original position in the event of a vehicle accident, and a method for controlling thereof.

Additional aspects of the present disclosure will be set forth in part in the description which follows and, in part, will be obvious from the description, or may be learned by practice of the present disclosure.

In accordance with one aspect of the present disclosure, a vehicle includes: a vehicle status sensor configured to detect a vehicle status; a seat control motor configured to move a sliding seat; and a controller configured to control the seat control motor to move the sliding seat to a predetermined original position when the vehicle status sensor detects an occurrence of an accident of the vehicle. In particular, the seat control motor, under control of the controller, is configured to move the sliding seat to a predetermined position from the predetermined original position before the accident of the vehicle occurs.

The vehicle may be a bus, and the predetermined position corresponds to a passage side position of the bus. The controller may control the seat control motor to move the sliding seat, which has been moved to the passage side of the vehicle, to the predetermined original position when the accident of the vehicle is detected.

The vehicle may further include: a fire detection sensor configured to detect a fire occurrence of the vehicle, and the vehicle status sensor may determine that the accident of the vehicle has occurred when the fire detection sensor detects the fire occurrence of the vehicle.

The vehicle may further include: a collision detection sensor configured to detect a collision of the vehicle, and the vehicle status sensor may determine that the accident of the vehicle has occurred when the collision detection sensor detects the collision of the vehicle.

The vehicle may further include a speed detector configured to detect a driving speed of the vehicle, and when the vehicle status sensor may detect the occurrence of an accident of the vehicle and the controller determines that the vehicle is stopped based on the driving speed of the vehicle, the controller may control the seat control motor to move the sliding seat to the predetermined original position.

The vehicle may further include: a camera configured to photograph a surrounding image of the vehicle, and an acceleration detector configured to detect a driving acceleration of the vehicle.

The controller may determine whether the vehicle is located on a slope way with a predetermined slope or more based on at least one of the photographed surrounding image or the detected driving acceleration.

The controller may control the seat control motor to move the sliding seat to the predetermined original position when the vehicle is not located on the slope way and the vehicle is not overturned when the accident of the vehicle is detected.

The vehicle may further include an inputter configured to receive a sliding seat movement command, and the controller may control the seat control motor to move the sliding seat to the predetermined original position based on the received sliding seat movement command.

In accordance with another aspect of the present disclosure, a method for controlling a vehicle may include: detecting, by a vehicle status sensor, an accident of the vehicle; determining, by a controller, whether the vehicle is stopped; determining, by the controller, whether the vehicle is on a slope way; determining, by the controller, whether the vehicle is overturned; and controlling, by the controller, a sliding seat of the vehicle to move to a predetermined position when the vehicle is stopped and the vehicle is not located on the slope way and the vehicle is not overturned.

The controlling the sliding seat to move to the predetermined position may include: controlling the sliding seat, which has been moved to a passage side of the vehicle, to move to the predetermined position corresponding to a predetermined original position when the accident of the vehicle is detected.

The detecting the accident of the vehicle may include: determining that the accident has occurred in the vehicle when a fire detection sensor detects a fire occurrence of the vehicle.

The detecting the accident of the vehicle may include: determining that the accident has occurred in the vehicle when a collision detection sensor detects a collision of the vehicle.

The method for controlling a vehicle may further include: detecting, by a speed sensor, a driving speed of the vehicle; and determining, by the controller, whether the vehicle is stopped based on the detected driving speed when the accident of the vehicle is detected, and controlling the seat control motor to move the sliding seat to the predetermined position when the vehicle is stopped.

The method for controlling a vehicle may further include: photographing, by a camera, the surrounding image of the vehicle; and detecting, by an acceleration sensor, a driving acceleration of the vehicle.

The method for controlling a vehicle may further include: determining, by the controller based on at least one of the photographed surrounding image or the detected driving acceleration, whether the vehicle is located on a slope way having a predetermined slope or more and whether the vehicle is overturned.

The method for controlling a vehicle may further include: controlling the seat control motor to move the sliding seat to the predetermined position when the vehicle is not in the slope way and the vehicle is not overturned when the accident of the vehicle is detected.

The method for controlling a vehicle may further include: receiving a sliding seat movement command; and controlling the sliding seat to move to the predetermined position based on the received sliding seat movement command.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is an external view of a typical bus;

FIG. 2 is a diagram illustrating a seat arrangement of a bus;

FIG. 3 is a detailed view of a seat shown in FIG. 2, particularly a perspective view before the seat is moved;

FIG. 4 is a detailed view of the seat shown in FIG. 2, particularly a perspective view after the seat is moved.

FIG. 5 is a control block diagram of a vehicle; and

FIG. 6 is a flowchart illustrating a control method of the vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following description, like reference numerals refer to like elements throughout the specification. Well-known functions or constructions are not described in detail since they would obscure the one or more exemplar forms with unnecessary detail. Terms such as “unit”, “module”, “member”, and “block” may be embodied as hardware or software. According to forms, a plurality of “unit”, “module”, “member”, and “block” may be implemented as a single component or a single “unit”, “module”, “member”, and “block” may include a plurality of components.

It will be understood that when an element is referred to as being “connected” another element, it can be directly or indirectly connected to the other element, wherein the indirect connection includes “connection via a wireless communication network”.

Also, when a part “includes” or “comprises” an element, unless there is a particular description contrary thereto, the part may further include other elements, not excluding the other elements.

It will be understood that, although the terms first, second, third, etc., may be used herein to describe various elements, but is should not be limited by these terms. These terms are only used to distinguish one element from another element.

As used herein, the singular forms “a,” “an” and “the” are intended to include the plural forms as well, unless the context clearly indicates otherwise.

An identification code is used for the convenience of the description but is not intended to illustrate the order of each step. The each step may be implemented in the order different from the illustrated order unless the context clearly indicates otherwise.

Reference will now be made in detail to forms of the present disclosure, examples of which are illustrated in the accompanying drawings.

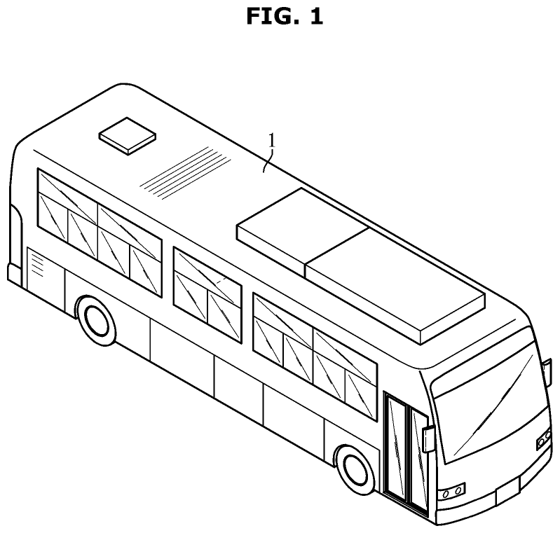

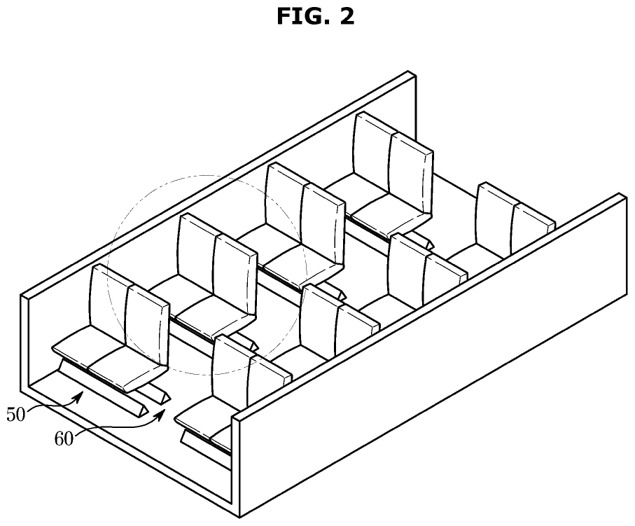

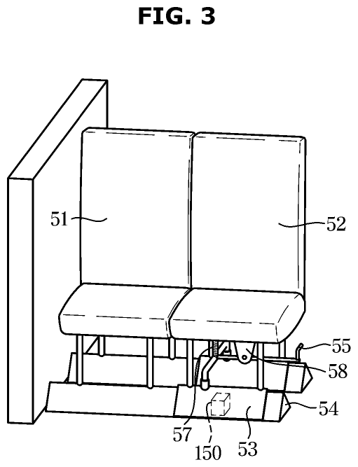

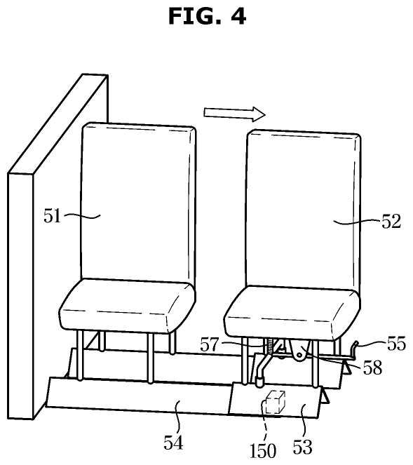

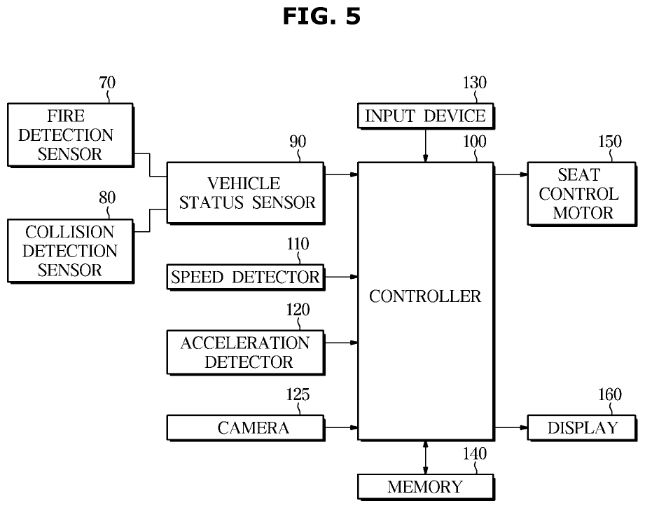

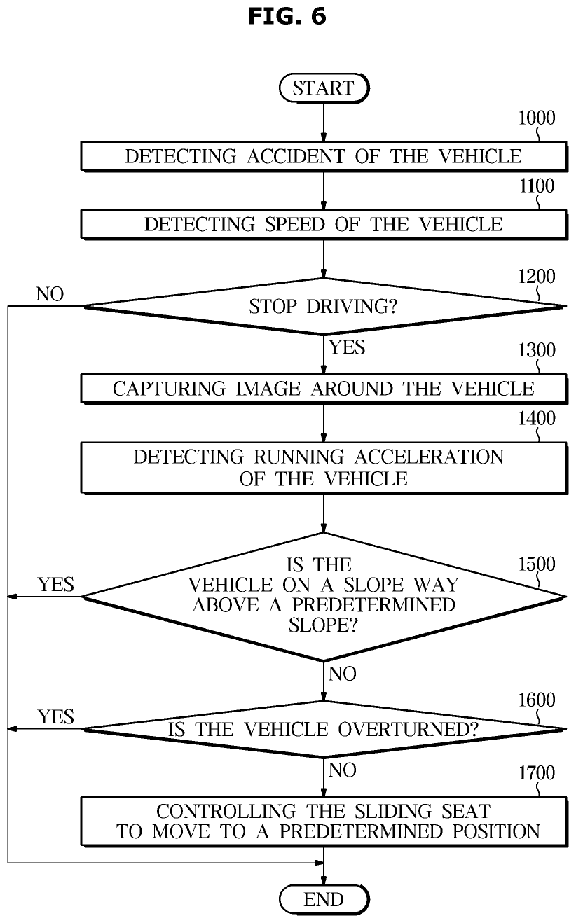

FIG. 1 is an external view of a typical bus, FIG. 2 is a diagram illustrating a seat structure of a bus according to one form of the disclosure. FIG. 3 is a detailed view of a seat shown in FIG. 2, particularly a perspective view before the seat is moved, FIG. 4 is a detailed view of the seat shown in FIG. 2, particularly a perspective view after the seat is moved. FIG. 5 is a control block diagram of a vehicle according to one form of the disclosure, and FIG. 6 is a flowchart illustrating a control method of the vehicle according to another form of the disclosure.

As shown in FIG. 1, a vehicle and a method of controlling the same according to one form of the disclosure will be described using a bus 1 as an example. However, the present disclosure may also be applied to a vehicle other than a bus.

Generally, in vans such as a bus 1 in FIG. 1, a two-person seat as illustrated in FIG. 2 is installed in the bus. Since these two-seat seats are usually determined by the standard size of the occupants, sitting side by side with passengers of a large body will not only make the shoulders close to each other, which makes the seats uncomfortable, and either side may be pushed back, and in particular in the case of summer, if you sit close, it becomes hot and uncomfortable.

Therefore, in order to solve this problem, the seat provided on the bus 1 may be provided with two rows of seats on at least one side of a central passage corresponding to an aisle of a body of the bus 1.

In addition, the seat structure of the bus 1 is provided so that people of large size can travel comfortably without contact with the person next to them by moving one seat in the direction of the center passage, which is a space not used during the running of the bus 1, to form a space between seats.

The seat may be implemented in the form of a sliding seat that can move left and right. Particularly, the sliding seat may be operated in a manual manner that can be moved manually by the user's operation, or in an automated manner that can automatically move under the control of the controller.

In the case of the automatic movement type, a seat control motor 150 for moving the seat under the control of the controller 100 may move the sliding seat in a predetermined direction. In addition, the user may move the sliding seat from side to side by inputting a user command.

Referring FIGS. 2 to 4, the sliding seat structure of the bus 1 according to one form of the present disclosure is provided with double row seats 50 on at least one side with respect to a passage 60 of the center of the vehicle body. The double row seats 50 may be configured as a fixed seat 51 fixed to the bottom surface of the vehicle body, a sliding seat 52 provided on the side of the fixed seat 51 so as to be movable laterally, a moving rail 53 for guiding the movement of the sliding seat 52, a guide rail 54 for guiding the movement of the moving rail 53, and a position fixing part to fix the position of the sliding seat 52 by fixing the moving rail 53 to the guide rail 54.

The fixed seat 51 is installed at the window side, and the sliding seat 52 may be installed at the passage 60 side of the center of the vehicle body. In addition, the double row seats 50 is installed on both sides of the central passage 60 in the case of the general bus 1, and in a new type of bus, such as a premium bus, which is to be installed on one side of the central passage 60.

First, when the sliding seat 52 is a manual operation form that is manually moved through the user's operation, the position fixing part may be composed of a handle 55 hinged to a bracket 58 formed below the sliding seat 52, a fastener 56 connected to the handle 55 and inserted into a groove of the guide rail 54 through a hole formed in the moving rail 53 to restrict movement of the moving rail 53, a return spring 57 in which one end is bound to the sliding seat 52 and the other end is bound to the handle 55 to spring the handle 55.

In this case, at least two grooves may be formed in the guide rail 54 to change the position of the sliding seat 52. In addition, the groove of the guide rail 54 and the hole of the moving rail 53 may be formed to be inclined in the lateral direction, to facilitate the entry and exit of the fixture 56.

The structure of the sliding seat 52 of the bus 1 may facilitate the occupant's convenience by moving the sliding seat 52 at a predetermined distance from the fixed seat 51 while the bus 1 is traveling.

When the sliding seat 52 is implemented in the form of an automatic movement that can automatically move under the control of the controller 100, as shown in FIGS. 3 and 4, the moving rail 53 is moved left and right along the guide rail 54 by the driving of the seat control motor 150 according to the control command of the controller 100, so that the sliding seat 52 can be moved in a predetermined direction.

That is, the user does not manually move the sliding seat 52 by operating the handle 55, but the user inputs a sliding seat 52 movement command through an inputter 150 or under the determination of the controller 100, the sliding seat 52 can be moved automatically.

When the passenger boards the bus 1, by attaching the sliding seat 52 and the fixed seat 51 of the double row seats 50, sufficient space is provided for the passage 60 to allow passengers to move through the passage 60. When the passenger's boarding is completed, the sliding seat 52 of the double row seats 50 is moved toward the central passage 60 so that the sliding seat 52 and the fixed seat 51 have a predetermined interval.

In this case, the position of the sliding seat 52 is changed as the moving rail 53 installed below the sliding seat 52 is moved along the guide rail 54, and when the sliding seat 52 is manually moved to a predetermined position, the position fixing unit is used to fix the position so that the sliding seat 52 does not move.

That is, after the sliding seat 52 is moved to an appropriate distance so that the hole of the moving rail 53 is aligned with the groove of the guide rail 54, the handle 55 is moved so that the fixture 56 fits into the groove of the guide rail 54 through the hole of the moving rail 53. Therefore, the movement of the moving rail 53 is limited so that the sliding seat 52 does not move.

On the other hand, in a state in which the sliding seat 52 is automatically moved to a predetermined position, when the seat control motor 150 is stopped, the sliding seat 52 is also stopped and fixed at the moved position.

As such, when the sliding seat 52 is moved so that the sliding seat 52 and the fixed seat 51 have a predetermined distance, the passengers seated in the sliding seat 52 or the fixed seat 51 will be able to travel comfortably without physical contact with each other. In particular, in the case of passengers traveling alone without accompaniment, discomfort due to physical contact with the next person does not occur, so that they can enjoy a pleasant trip. According to the taste of the passenger can also be used to attach the fixed seat 51 without moving the sliding seat 52, it can also adjust the distance between the person by adjusting the position between the sliding seat 52 and the fixed seat 51.

When the passengers want to get off after the bus stops, the passengers are smoothly moved by attaching the sliding seats 52 to the fixed seats 51 through manual operation or automatic control to secure the space of the passage 60.

On the other hand, while the sliding seat 52 is moved in the passage 60 direction can be secured between the seats, but in the case of a fire or a collision accident in the bus 1, the passage 60 narrowed due to the movement of the sliding seat 52 may impede the rapid escape of the passenger.

Therefore, there is a need to secure an escape passage in an emergency situation by causing an accident in the bus 1 or automatically shifting the sliding seat 52 toward the fixed seat 51 as desired.

Referring to FIG. 5, the bus 1 according to one form may include a fire detection sensor 70 detecting a fire occurrence of the bus 1, a collision detection sensor 80 detecting a collision of the bus 1, and a vehicle status sensor 90 for detecting the state of the bus 1, such as whether an accident has occurred, the controller 100 for controlling the operation of each component of the bus 1, a speed detector 110 detecting the traveling speed of the bus 1, an acceleration detector 120 detecting the acceleration of the vehicle body of the bus 1 while the bus 1 is being driven, a camera 125 photographing the surrounding images of the bus 1, an inputter 130 receiving a control command related to an operation, a memory 140 storing data related to the operation of the bus 1, the seat control motor 150 for moving the sliding seat 52, and a display 160 for displaying information related to the operation of each component of the bus 1.

As described above, when an accident occurs in the bus 1 or when desired, the sliding passage 52 is automatically returned to the fixed seat 51 to secure an escape passage in an emergency situation, but if an accident occurs, unconditionally returning the sliding seat 52 may cause other risks.

In other words, even when an accident occurs in the bus 1, the sliding seat 52 may not be returned when the bus 1 is being driven without stopping or when the bus 1 is overturned or stopped in a dangerous place. For example, even when the bus 1 is overturned, when the sliding seat 52 is forcibly returned to its original position, secondary damage may occur to the passenger due to a seat jamming.

Therefore, when an accident occurs in the bus 1, it is desired to determine whether to move the sliding seat 52 in consideration of the current driving state and the driving situation of the bus 1.

Referring FIG. 6, the vehicle status sensor 90 may detect an accident occurrence of the bus 1 (1000).

The vehicle status sensor 90 may determine that an accident has occurred in the bus 1 when the fire detection sensor 70 detects a fire occurrence in the bus 1, and may determine that an accident has occurred in the bus 1 when the collision detection sensor 80 detects a collision of the bus 1.

The fire detection sensor 70 and the collision detection sensor 80 are provided at a predetermined position of the bus 1 to detect a fire occurring on the bus 1 and the collision between the bus 1 and another object, and to transmit the data to the vehicle status sensor 90.

In addition, the vehicle status sensor 90 may determine the occurrence of the collision of the bus 1 on the basis of a deployment signal in which the airbag provided in the bus 1 is deployed. Alternatively, when it is determined that the current driving state of the bus 1 is difficult to avoid collision with the object on the basis of the detection result of the detection sensor (not shown), which acquires the position information and the speed information of another object around the bus 1, and the driving speed of the bus 1 detected by the speed detector 110, the vehicle status sensor 90 may determine that the collision of the bus 1 occurs.

When the vehicle status sensor 90 detects the occurrence of an accident of the bus 1, the speed detector 110 may detect the current driving speed of the bus 1, and the controller 100 may determine whether driving of the bus 1 is stopped according to the detection result of the speed detector 110 (1200).

That is, even when the vehicle status sensor 90 detects the occurrence of the accident of the bus 1, when the driving of the bus 1 is not stopped, the controller 100 may control the seat control motor 150 such that the sliding seat 52 does not move to the original position toward the fixed seat 51.

In addition, the camera 125 provided on the bus 1 may take a peripheral image of the road on which the bus 1 is driving (1300), and the acceleration detector 120 may detect the vehicle body acceleration of the bus 1 to obtain acceleration information of the bus 1 (1400). The acceleration detector 120 may be implemented as an acceleration sensor, and acceleration information of the bus 1 may be obtained by the acceleration sensor.

On the other hand, the controller 100 may obtain data on the gradient of the road on which the bus 1 stops and whether the bus 1 is overturned based on the wheel acceleration information obtained by differentiating the rotational speed of the wheel of the bus 1 and the acceleration information detected by the acceleration detector 120. That is, the controller 100 may obtain the gradient value of the road, on which the current bus 1 stops, by receiving the rotational speeds of the wheels detected at predetermined time intervals a predetermined number of times, averaging the rotational speeds of the detected wheels a predetermined number of times, dividing the averaged wheel rotational speeds by a predetermined time to determine the wheel acceleration and comparing the acceleration of the bus 1 detected by the acceleration detector 120 with the wheel acceleration.

In addition, the controller 100 may determine whether the bus 1 is overturned by using the difference between the gradient value of the current position of the bus 1 and the acceleration value of the z-axis with respect to the driving direction of the bus 1.

The controller 100 may also determine whether the vehicle is located on a severe hill and whether the bus 1 is overturned based on the image data around the bus 1 received from the camera 125 and the acceleration information of the bus 1 received from the acceleration detector 120 and the gradient value information of the road corresponding to the current stop position of the bus 1.

That is, the controller 100 may determine whether the bus 1 is located at a slope way a predetermined slope or more based on the image photographing result of the camera 125 (1500), and may determine whether the bus 1 is currently overturned (1600).

Based on the bus 1 traveling speed detection result of the speed detector 110 and the bus 1 acceleration detection result of the acceleration detector 120, when a longitudinal acceleration value remains within a predetermined value for a predetermined time in a state in which the bus 1 stops, the controller 100 may determine that the bus 1 is located at a slope way more than a predetermined slope.

In addition, the controller 100 may determine that the bus 1 is overturned when a lateral acceleration value is greater than or equal to a predetermined value when the bus 1 stops.

When an accident of bus 1 is detected and the bus 1 is stopped and not located on the slope way and the bus 1 is not overturned, the controller 100 may control the seat control the seat control motor 150 to move the sliding seat 52 to a predetermined original position (1700).

That is, when the current state of the bus 1 meets a certain condition at the time of the accident of the bus 1, the controller 100 controls the sliding seat 52 to move toward the fixed seat 51, a space for the passage 60 may be provided and escape passages may be secured in emergencies.

As in FIG. 3, the position where the sliding seat 52 is located next to the fixed seat 51 is defined as a first position, and as in FIG. 4, the position where the sliding seat 52 is located toward the passage 60 is defined as a second position, the controller 100 may control the seat control motor 150 so that the sliding seat 52 is positioned at the second position during normal driving of the bus 1 so that a comfortable space may be provided between the occupants.

In the event of an accident on the bus 1, the controller 100 controls the seat control motor 150 to move the sliding seat 52 from the second position to the first position to secure an escape passage of the passage 60.

As described above, the bus 1 may include an inputter 130 that receives a control command related to the operation of the bus 1, and the controller 100 may control the seat control motor 150 to move the sliding seat 52 to a predetermined first position or second position according to a movement command of the sliding seat 52 received from the user.

The memory 140 may be implemented by using at least one of a non-volatile memory element, e.g., a cache, a Read Only Memory ROM), a Programmable ROM (PROM), an Erasable Programmable ROM (EPROM), an Electrically Erasable Programmable ROM (EEPROM) and a flash memory, a volatile memory element, e.g., a Random Access Memory (RAM), or a storage medium, e.g., a Hard Disk Drive (HDD) and a CD-ROM. The implementation of the memory 90 is not limited thereto. The memory 90 may be a memory that is implemented by a separate memory chip from the aforementioned processor related to the controller 100 or the memory 90 may be implemented by a processor and a single chip.

In addition, the bus 1 may include a display 160, and the display 160 displays a control state of the sliding seat 52 according to the control of the controller 100, and thus the driver may be provided with information about the position and the movement of the sliding seat 52.

According to a vehicle and a control method thereof according to exemplary forms of the present disclosure, there is an effect that the sliding seat is automatically returned to its original position in the event of an accident of the vehicle, thereby securing an escape route in the event of an emergency, thereby helping to quickly evacuate passengers and protect lives. In addition, since the sliding seat is automatically returned to the original position, there is an effect that can easily organize the vehicle after all the passengers get off.

The disclosed forms may be implemented in the form of a recording medium that stores instructions executable by a computer. The instructions may be stored in the form of program code and may perform the operations of the forms disclosed by creating a program module when executed by a processor. The recording medium may be implemented in a computer-readable recording medium.

The computer readable recording medium may include various kinds of recording medium in which an instruction decrypted by the computer system is stored. For example, the computer readable recording medium may include a Read Only Memory (ROM), a Random Access Memory (RAM), a magnetic tape, a magnetic disk, a flash memory, and an optical data storage device.

As is apparent from the above description, according to the proposed vehicle and method for controlling thereof, in the event of a vehicle accident, the sliding seat is automatically returned to its original position to secure an escape route in the event of an emergency, thereby helping passengers to evacuate quickly and protect lives. In addition, the sliding seat is automatically returned to the original position has the effect that can easily organize the vehicle after all the passengers get off.

Although a few forms of the present disclosure have been shown and described, it would be appreciated by those skilled in the art that changes may be made in these forms without departing from the principles and spirit of the disclosure.

What is claimed is:

1. A vehicle comprising:
a vehicle status sensor configured to detect a vehicle status; and
a controller configured to control a movement of a sliding seat of the vehicle to be at a predetermined original position when the vehicle status sensor detects an occurrence of an accident of the vehicle.

2. The vehicle of claim 1, further comprising: a seat control motor, under control of the controller, configured to move the sliding seat to a predetermined position from the predetermined original position before the accident of the vehicle occurs,
wherein the vehicle is a bus and the predetermined position corresponds to a passage side position of the bus.

3. The vehicle of claim 1, further comprising:
a fire detection sensor configured to detect a fire occurrence of the vehicle,
wherein the vehicle status sensor determines that the accident of the vehicle has occurred when the fire detection sensor detects the fire occurrence of the vehicle.

4. The vehicle of claim 1, further comprising:
a collision detection sensor configured to detect a collision of the vehicle,
wherein the vehicle status sensor determines that the accident of the vehicle has occurred when the collision detection sensor detects the collision of the vehicle.

5. The vehicle of claim 1, further comprising:
a speed detector configured to detect a driving speed of the vehicle;
wherein when the vehicle status sensor detects the occurrence of an accident of the vehicle, and the controller determines that the vehicle is stopped based on the driving speed of the vehicle, the controller is configured to control the movement of the sliding seat to be at the predetermined original position.

6. The vehicle of claim 5, further comprising:
a camera configured to photograph a surrounding image of the vehicle; and
an acceleration detector configured to detect a driving acceleration of the vehicle.

7. The vehicle of claim 6, wherein
the controller is configured to determine whether the vehicle is located on a slope way with a predetermined slope or more based on at least one of the photographed surrounding image or the detected driving acceleration of the vehicle.

8. The vehicle of claim 7, wherein
the controller is configured to control the movement of the sliding seat to be at the predetermined original position when the vehicle is not located on the slope way and the vehicle is not overturned when the accident of the vehicle is detected.

9. The vehicle of claim 1, further comprising:
an inputter configured to receive a sliding seat movement command;
wherein the controller is configured to control a seat control motor to move the sliding seat to the predetermined original position based on the received sliding seat movement command.

10. A method for controlling a vehicle, comprising:
detecting, by a vehicle status sensor, an accident of the vehicle;
determining, by a controller, whether the vehicle is stopped;
determining, by the controller, whether the vehicle is on a slope way;
determining, by the controller, whether the vehicle is overturned; and
controlling, by the controller, a sliding seat of the vehicle to move to a predetermined position when the vehicle is stopped and the vehicle is not located on the slope way and the vehicle is not overturned.

11. The method of claim 10, wherein controlling the sliding seat to move to the predetermined position includes:
controlling the sliding seat, which has been moved to a passage side of the vehicle, to move to the predetermined position corresponding to a predetermined original position when the accident of the vehicle is detected.

12. The method of claim 10, wherein detecting the accident of the vehicle includes:
determining that the accident has occurred in the vehicle when a fire detection sensor detects a fire occurrence of the vehicle.

13. The method of claim 10, wherein detecting the accident of the vehicle includes:
determining that the accident has occurred in the vehicle when a collision detection sensor detects a collision of the vehicle.

14. The method of claim 10, further comprising:
detecting, by a speed sensor, a driving speed of the vehicle; and
determining, by the controller, whether the vehicle is stopped based on the detected driving speed when the accident of the vehicle is detected, and controlling a seat control motor to move the sliding seat to the predetermined position when the vehicle is stopped.

15. The method of claim 14, further comprising:
photographing, by a camera, a surrounding image of the vehicle; and
detecting, by an acceleration sensor, a driving acceleration of the vehicle.

16. The method of claim 15, wherein
the controller is configured to determine, based on at least one of the photographed surrounding image or the detected driving acceleration, whether the slope way has a predetermined slope or more and whether the vehicle is overturned.

17. The method of claim 16, further comprising:
controlling the seat control motor to move the sliding seat to the predetermined position when the vehicle is not in the slope way and the vehicle is not overturned when the accident of the vehicle is detected.

18. The method of claim 10, further comprising:
receiving a sliding seat movement command; and
controlling the sliding seat to move to the predetermined position based on the received sliding seat movement command.
